(19) United States
(12) Patent Application Publication
(10) Pub. No.: US 2018/0114522 A1
(43) Pub. Date: Apr. 26, 2018

(54) SEQUENCE TO SEQUENCE TRANSFORMATIONS FOR SPEECH SYNTHESIS VIA RECURRENT NEURAL NETWORKS

(71) Applicant: Semantic Machines, Inc., Newton, MA (US)

(72) Inventors: David Leo Wright Hall, Berkeley, CA (US); Daniel Klein, Orinda, CA (US); Daniel Roth, Newton, MA (US); Lawrence Gillick, Newton, MA (US); Andrew Maas, Berkeley, CA (US); Steven Wegmann, Berkeley, CA (US)

(73) Assignee: Semantic Machines, Inc., Newton, MA (US)

(21) Appl. No.: 15/792,236

(22) Filed: Oct. 24, 2017

Related U.S. Application Data
(60) Provisional application No. 62/412,165, filed on Oct. 24, 2016.

(51) Int. Cl. G10L 13/047; G10L 13/10

(52) U.S. Cl. CPC G10L 13/047; G10L 15/22; G10L 13/10

(57) ABSTRACT

A system eliminates alignment processing and performs TTS functionality using a new neural architecture. The neural architecture includes an encoder and a decoder. The encoder receives an input and encodes it into vectors. The encoder applies a sequence of transformations to the input and generates a vector representing the entire sentence. The decoder takes the encoding and outputs an audio file, which can include compressed audio frames.

### CROSS-REFERENCE TO RELATED APPLICATIONS

This application claims the priority benefit of U.S. Provisional Application Ser. No. 62/412,165, titled “Sequence to Sequence Transformations for Speech Synthesis via Recurrent Neural Networks,” filed Oct. 24, 2016, the disclosure of which is incorporated herein by reference.

### BACKGROUND

In typical speech recognition systems and input utterance is received, a request within the utterances process, and an answer is provided via speech. As such, speech recognition systems include a text-to-speech (TTS) mechanism for converting an answer in text format into speech format.

In normal TTS systems, output taxes translated to a representation of sounds. The TTS system can align sounds to audio at a fine-grained level. A challenge exists in alignment methods and that sounds should be broken up at the same place for the same syllable. Performing alignment to generate speech from text requires large amounts of audio processing and other knowledge. When converting text to a correct pronunciation, the system must get the particular pronunciation correct. For example, heteronyms are pronounced differently in different contexts, such as the word “dove” when referring to a bird as opposed to a reference to diving. It can also be tough for TTS systems to determine the end and start of neighboring consonants.

What is needed is an improved text-to-speech system.

### SUMMARY

The present system, roughly described, eliminates alignment processing and performs TTS functionality using a new neural architecture. The neural architecture includes an encoder and a decoder. The encoder receives an input and encodes it into vectors. The encoder applies a sequence of transformations to the input and generates a vector representing the entire sentence. The decoder takes the encoding and outputs an audio file, which can include compressed audio frames.

In some implementations, a method can perform speech synthesis. The method may include receiving one or more streams of input by one or more decoders implemented on a computing device. A context vector can be generated by the one or more encoders. The context vector can be decoded by a decoding mechanism implemented on the computing device. The decoded context vectors can be fed into a neural network implemented on the computing device; and an audio file can be output by the neural network.

In some instances, a system can perform speech synthesis. The system can include one or more encoder modules and a decoder module. The one or more encoder modules can be stored in memory and executable by a processor that when executed receive one or more streams of input and generate a context vector for each stream. The decoder module can be stored in memory and executable by a processor that when executed decodes the context vector, feeds the decoded context vectors into a neural network, provides an audio file from the neural network.

### BRIEF DESCRIPTION OF FIGURES

FIG. 1 is a block diagram of an automated assistant that performs TTS.

FIG. 2 is a block diagram of a server-side implementation of an automated assistant that performs TTS.

FIG. 3 is a block diagram of a TTS training system.

FIG. 4 is a method for performing TTS using a neural network.

FIG. 5 is a method for computing a context vector.

FIG. 6 illustrates a computing environment for implementing the present technology.

### DETAILED DESCRIPTION

The present system, roughly described, eliminates alignment within text-to-speech processing and performs TTS functionality using a new neural architecture. The neural architecture includes an encoder and a decoder. The encoder receives an input and encodes it into vectors. The encoder applies a sequence of transformations to the input and generates a vector representing the entire sentence. The decoder takes the encoding and outputs an audio file, which can include compressed audio frames.

The present system does not use explicit allocations of frames to phones or even to words. It can be used with any audio codec that has fixed length frames and accepts a fixed number of (possibly quantized) floating point or codebook parameters for each frame. The present TTS system applies zero or more phases of analysis to the text (tokenization, POS tagging, text normalization, pronunciations, prosodic markup, etc), to produce additional streams of input. These streams of input (possibly including the original text) are then fed to the neural network for processing

The neural network starts in “encoding mode”, where it computes a context vector for each item in each stream. It then enters “decoding mode”, where it emits frames of compressed audio as floating-point vectors. To emit a frame, for each stream it computes an “attention vector” as a function of each input item's context vector and a context vector from its recurrent state (e.g. dot product). The attention vector can be normalized via a softmax function to give a probability distribution \alpha_s for each stream. The neural network then computes sum_s \sum_i \alpha_{si} h_{s,i}, which is an implicit alignment vector. The alignment vector and the neural networks' recurrent state are then fed through a standard neural network to produce the frame and a new recurrent state. Eventually, the TTS system outputs a special “stop” frame that signals that processing shall end.

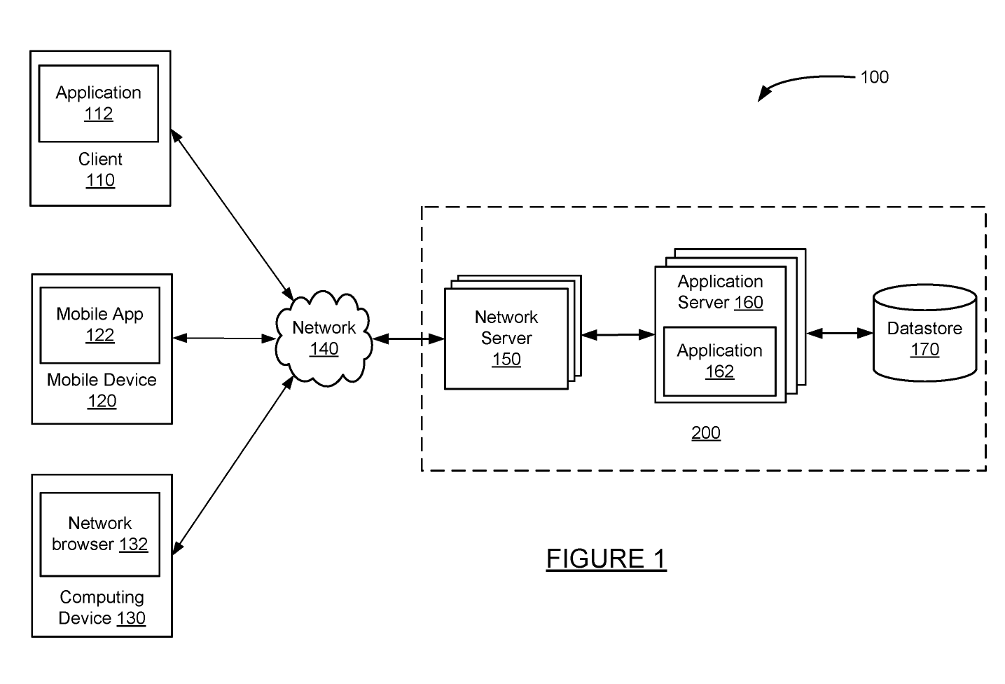

FIG. 1 is a block diagram of an automated assistant that performs TTS. System 100 of FIG. 1 includes client 110, mobile device 120, computing device 130, network 140, network server 150, application server 160, and data store 170. Client 110, mobile device 120, and computing device 130 communicate with network server 150 over network 140. Network 140 may include a private network, public network, the Internet, and intranet, a WAN, a LAN, a cellular network, or some other network suitable for the transmission of data between computing devices of FIG. 1.

Client 110 includes application 112. Application 112 may provide an automated assistant, TTS functionality, automatic speech recognition, paraphrase decoding, transducing and/or translation, paraphrase translation, partitioning, and other functionality discussed herein. Application 112 may be implemented as one or more applications, objects, modules or other software. Application 112 may communicate with application server 160 and data store 170 through the server architecture of FIG. 1 or directly (not illustrated in FIG. 1) to access data.

Mobile device 120 may include a mobile application 122. The mobile application may provide an automated assistant, TTS functionality, automatic speech recognition, paraphrase decoding, transducing and/or translation, paraphrase translation, partitioning, and other functionality discussed herein. Mobile application 122 may be implemented as one or more applications, objects, modules or other software, and may operate to provide services in conjunction with application server 160.

Computing device 130 may include a network browser 132. The network browser may receive one or more content pages, script code and other code that when loaded into the network browser provides an automated assistant, TTS functionality, automatic speech recognition, paraphrase decoding, transducing and/or translation, paraphrase translation, partitioning, and other functionality discussed herein. The content pages may operate to provide services in conjunction with application server 160.

Network server 150 may receive requests and data from application 112, mobile application 122, and network browser 132 via network 140. The request may be initiated by the particular applications or browser applications. Network server 150 may process the request and data, transmit a response, or transmit the request and data or other content to application server 160.

Application server 160 includes application 162. The application server may receive data, including data requests received from applications 112 and 122 and browser 132, process the data, and transmit a response to network server 150. In some implementations, the responses are forwarded by network server 152 to the computer or application that originally sent the request. Application's server 160 may also communicate with data store 170. For example, data can be accessed from data store 170 to be used by an application to provide TTS functionality, automatic speech recognition, paraphrase decoding, transducing and/or translation, paraphrase translation, partitioning, an automated assistant, and other functionality discussed herein. Application server 160 includes application 162, which may operate similar to application 112 except implemented all or in part on application server 160.

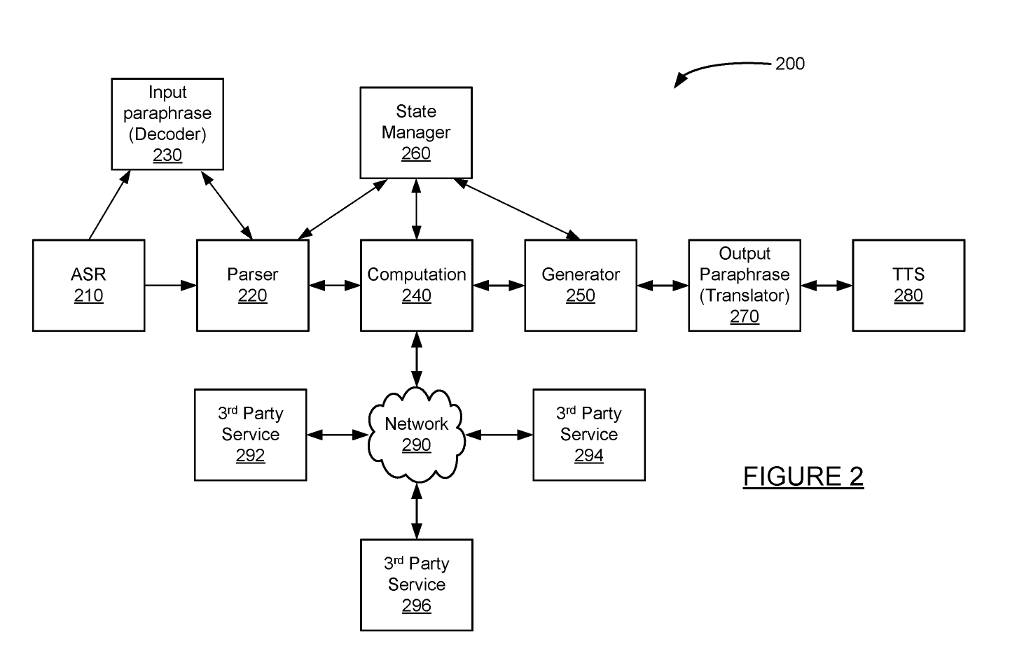

Block 200 includes network server 150, application server 160, and data store 170, and may be used to implement an automated assistant that includes a TTS system. In some instances, block 200 may include a TTS module to convert output text into speech. Block 200 is discussed in more detail with respect to FIG. 2.

FIG. 2 is a block diagram of a server-side implementation of an automated assistant that performs TTS. System 200 of FIG. 2 includes automatic speech recognition (ASR) module 210, parser 220, input paraphrase module (decoder) 230, computation module 240, generator 250, state manager 260, output paraphrase module (translator) 270, and text to speech (TTS) module 280. Each of the modules may communicate as indicated with arrows and may additionally communicate with other modules, machines or systems, which may or may not be illustrated FIG. 2.

Automatic speech recognition module 210 may receive audio content, such as content received through a microphone from one of client 110, mobile device 120, or computing device 130, and may process the audio content to identify speech. The speech may be provided to decoder 230 as well as parser 220.

Parser 220 may interpret a user utterance into intentions. In some instances, parser 220 may produce a set of candidate responses to an utterance received and recognized by ASR 210. Parser 220 may generate one or more plans, for example by creating one or more cards, using a current dialogue state received from state manager 260. In some instances, parser 220 may select and fill a template using an expression from state manager 260 to create a card and pass the card to computation module 240.

Decoder 230 may decode received utterances into equivalent language that is easier for parser 220 to parse. For example, decoder 230 may decode an utterance into an equivalent training sentence, trading segments, or other content that may be easily parsed by parser 220. The equivalent language is provided to parser 220 by decoder 230.

Computation module 240 may examine candidate responses, such as plans, that are received from parser 220. The computation module may rank them, alter them, may also add to them. In some instances, computation module 240 may add a “do-nothing” action to the candidate responses. Computation module may decide which plan to execute, such as by machine learning or some other method. Once the computation module determines which plan to execute, computation module 240 may communicate with one or more third-party services 292, 294, or 296, to execute the plan. In some instances, executing the plan may involve sending an email through a third-party service, sending a text message through third-party service, accessing information from a third-party service such as flight information, hotel information, or other data. In some instances, identifying a plan and executing a plan may involve generating a response by generator 250 without accessing content from a third-party service.

State manager 260 allows the system to infer what objects a user means when he or she uses a pronoun or generic noun phrase to refer to an entity. The state manager may track “salience”—that is, tracking focus, intent, and history of the interactions. The salience information is available to the paraphrase manipulation systems described here, but the other internal workings of the automated assistant are not observable.

Generator 250 may receive a structured logical response from computation module 240. The structured logical response may be generated as a result of the selection of can at response to execute. When received, generator 250 may generate a natural language response from the logical form to render a string. Generating the natural language response may include rendering a string from key-value pairs, as well as utilizing silence information for information pass along from computation module 240. Once the strings are generated, they are provided to a translator 270.

Translator 270 transforms the output string to a string of language that is more natural to a user. Translator 270 may utilize state information from state manager 260 to generate a paraphrase to be incorporated into the output string.

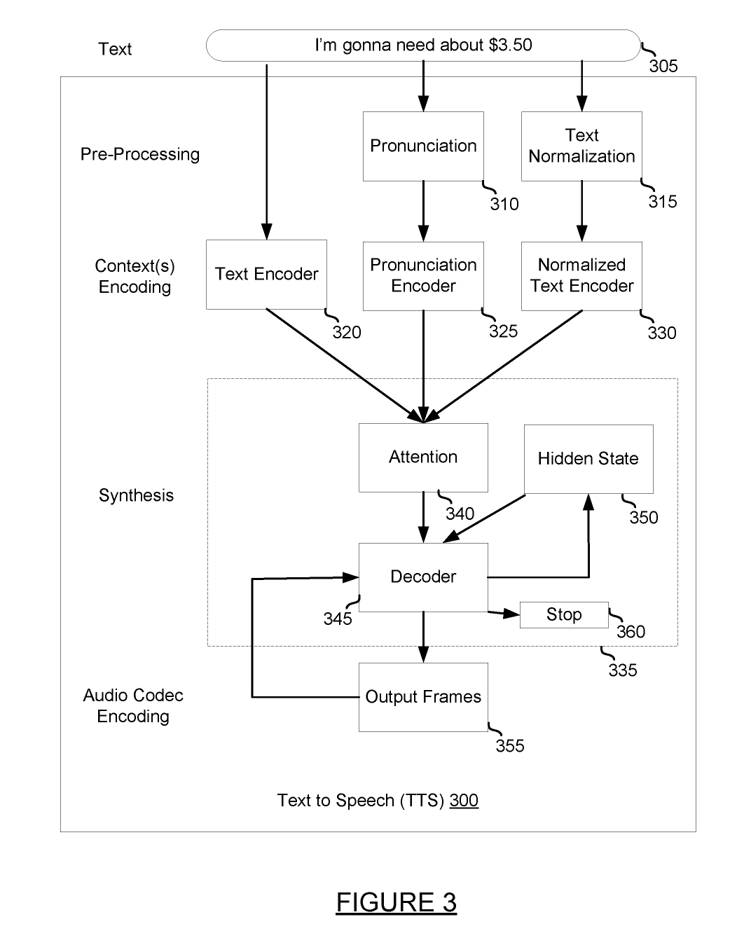

TTS receives the paraphrase from translator 270 and performs speech synthesis based on the paraphrase using a neural network system. The generated speech (e.g., an audio file) is then output by TTS 280. TTS 280 is discussed in more detail below with respect to FIG. 3.

Each of modules 210, 220, 230, 240, 250, 260, 270, 292, 294, and 296 may be implemented in a different order, more than once, combined with other modules, or may be optional in the system of FIG. 2.

Additional details regarding the modules of Block 200, including a parser, state manager for managing salience information, a generator, and other modules used to implement dialogue management are described in U.S. patent application Ser. No. 15/348,226 (the '226 application), entitled “interaction assistant,” filed on Nov. 10, 2016, which claims the priority benefit to U.S. provisional patent application 62/254,438, titled “attentive communication assistant,” filed on Nov. 12, 2015, the disclosures of which are incorporated herein by reference.

FIG. 3 is a block diagram of a TTS training system 300. The TTS training system 300 of FIG. 3 provides more detail of TTS module 280 of FIG. 2. The TTS system 300 includes a text input o305 of “I'm gonna need about $3.50.” The input make take the form of a sequence of annotations, such as various linguistic properties of the text. The annotations can include the original text (received by text encoder 320), a phonetic “pronounced” version 310 of the text (received by pronunciation encoder 325 in FIG. 3) in Arpabet or in IPA or some other representation, a normalized version 315 of the original text as received by normalized text encoder 330, and other annotations. Other inputs/annotations may be used in addition to these examples, and such inputs may include any kind of (automatically or manually derived) linguistic annotation like syntactic parses, part of speech tags, clause boundaries, emphasis markers, and the like. In addition, automatically induced features like word embedding vectors can be used.

Encoders 320-330 may generate context vectors from the received annotation inputs. The system, operating under the “encoder/decoder” paradigm in neural networks, first encodes each input stream into a sequence of vectors, one for each position in each stream. Each stream is encoded by letting a model soft-search for a set of input words, or their annotations computed by an encoder, when generating each target word. This frees the model from having to encode a whole source sentence into a fixed-length vector, and also allows the model to focus on information relevant to the generation of the next target word. This has a major positive impact on the ability of the neural machine translation system to yield good results on longer sentences.

Though this is one example of generating context vectors, the present TTS system may be extended to process an input stream in a different way. In any case, these vectors will be used as the “context” vectors cₛᵢ for each position i in each stream s. The dimensionality of these vectors can be configured to suit the desired application.

The encoders 320-330 can also generate other optional input. Symbolic entries like phones and words can be encoded using a “one-hot” representation. These additional elements may be provided to the input layer of the neural network, and the network itself will discover appropriate context dependencies if they exist in the data.

Alternatively, if enough data exists, it is possible to discover some of these additional markups within the neural network rather than providing them externally. In some instances, providing the system with prosodic cues like emphasis markers may be useful so that external processes can guide the prosody of the sentence. That is, a system—such as an automated dialogue system—that is providing input to this system can indicate that a particular word should be emphasized.

In some instances, the TTS system may operate in a “vocoding” mode. In this mode, the TTS system can be provided with an input representing the proposed output signal according to some other TTS system. In this implementation, the original text and/or phonetic representation are optional. The input received from another TTS system may be the units from a concatenative synthesis system, which may be suitable transformed, or the spectra or other vocoder parameters output by a normal parametric system. The TTS system can be trained to reproduce the original audio signal to the best of its ability. In this mode, the TTS system is used to smooth so-called “join artifacts” produced by concatenation to make the signal more pleasant or to improve over the simplifying assumptions that parametric vocoders make.

During training, the system learns to predict a provided sequence of output vectors. These output vectors may be any representation of an audio file that can be processed to produce an actual audio signal. For instance, they may be the parameters expected by a parametric TTS system's vocoder, or it may be the (suitably transformed) parameters to a standard audio file format like a WAV file, FLAC, MP3, Speex, or Opus. Codecs like Speex and Opus are likely to produce better results, as they were specifically designed to encode speech effectively. The system also expects a function to post-process the outputs to be turned into the appropriate file format. We discuss choice of output representation below.

In some instances, the TTS system processes the entirety of the input streams immediately, and then starts decoding. Hence, encoding can be performed for one or more streams, including all the streams, as soon as the streams are received.

After the encoding mode performed by encoders 320-330 of FIG. 3, the TTS system enters “decoding mode” where it performs operations that result in emitting compressed audio (audio frames) as floating point vectors. These operations can be performed by modules 340-360 within block 335.

To emit a frame, for each stream, the decoding block 335 computes an “attention vector” as a function of each input item's context vector and a context vector from its recurrent state (e.g. dot product). This attention vector can be generated by attention module 340 and is normalized via softmax to give a probability distribution \alpha_s for each stream. The neural network then computes sum_s \sum_i \alpha_{si} h_{s,i}, which is an implicit alignment vector. The attention vector and the neural networks' recurrent state are then fed through the standard neural network to produce the frame and a new recurrent state. Eventually, the decoder block 335 outputs a special “stop” frame that signals that decoding is done. Decoding stops when the decoder emits a stop frame (which may be triggered, initiated, and/or generated by stop module 360). The decoder 345 produces output frames 355 which include audio files that can be output through a speaker on a smart phone, tablet, or other computing device.

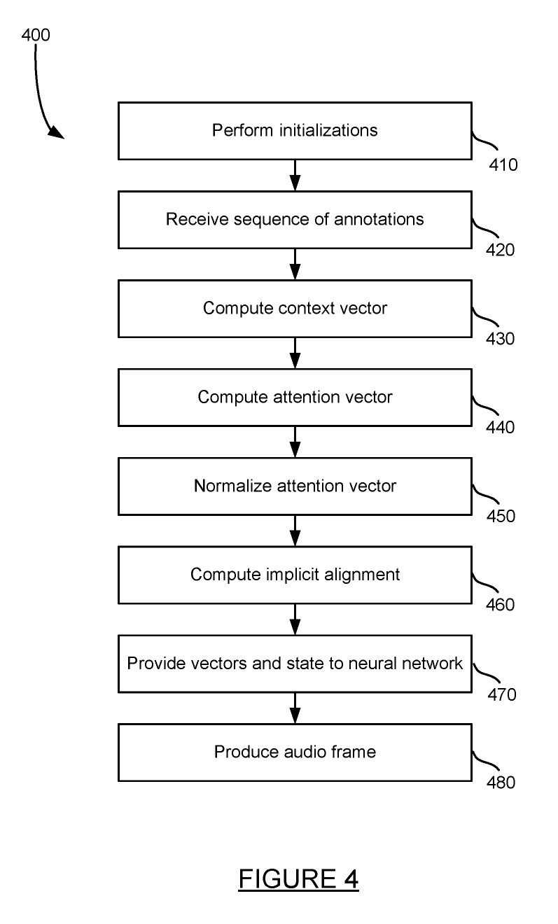

FIG. 4 is a method for performing TTS using a neural network. Initializations are performed at step 410. The initializations may include initializing a hidden state h, for example setting H to zero or setting it randomly and to initialize an output vector o, for example to a representation of silence. A sequence of annotations may be received at step 420. The annotations may include various linguistic properties of the text. The annotations can include the original text (received by text encoder 320), a phonetic “pronounced” version 310 of the text (received by pronunciation encoder 325 in FIG. 3) in Arpabet or in IPA or some other representation, a normalized version 315 of the original text as received by normalized text encoder 330, and other annotations. Other inputs/annotations may be used in addition to these examples, and such inputs may include any kind of (automatically or manually derived) linguistic annotation like syntactic parses, part of speech tags, clause boundaries, emphasis markers, and the like. In addition, automatically induced features like word embedding vectors can be used.

A context vector may be computed at step 430. The context vector may be computed by an encoder for each received stream. The context vector is generated by letting a model soft-search for a set of input words, or their annotations computed by an encoder, when generating each target word. This frees the model from having to encode a whole source sentence into a fixed-length vector, and also allows the model to focus on information relevant to the generation of the next target word.

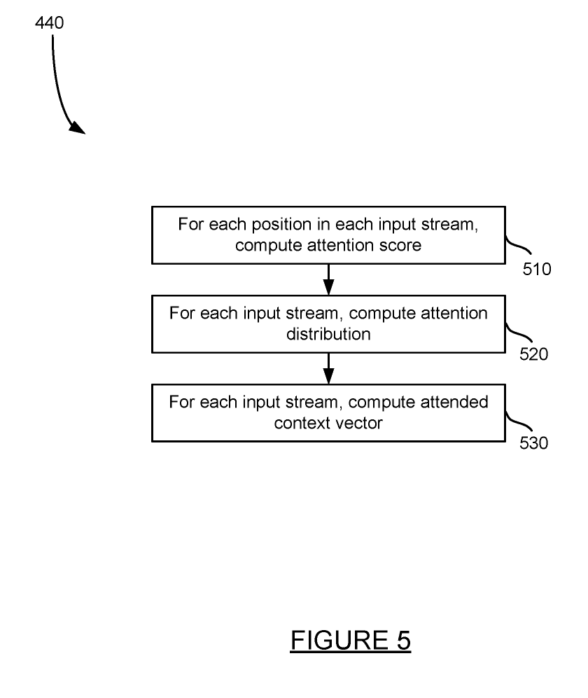

Attention vectors may then be computed at step 440. The attention vector is generated during a decoding phase of the neural network operation. Generating the attention vector may include computing attention scores, attention distribution, and an attended context vector. More detail for generating an attention vector is discussed with respect to the method of FIG. 5.

An implicit alignment is computed at step 460. An alignment vector and neural network recurrent state are then provided to a standard neural network at step 470. The audio frame is then produced at step 480.

FIG. 5 is a method for computing a context vector. The method of FIG. 5 provides more detail for step 450 of the method of FIG. 4. Method of FIG. 4 may be performed until a stop marker is generated by the present system. For each input stream s received by the present system, and for each position in each input stream i, an attention score score aₛᵢ=f_{attend}(h, cₛᵢ) is computed at step 510. An attention distribution dₛ=exp(aₛ)/sumₛ(exp(aₛ)) is computed for each input stream at step 520. The attended context vector vₛ=sum(dₛᵢ*cₛᵢ) is computed for each input stream at step 530.

Additional computations that are performed include computing the complete context vector v=sumₛ(vₛ) and computing (h′, o′, stop)=fₑₘᵢₜ(h, v, o). The system generates output o, sets o=o′ and sets h=h′. Once a stop mark is received, the system stops processing the received input streams. If there is no stop mark detected, the system continues to perform the operations discussed with respect to FIG. 5.

In the computations discussed above, fₑₘᵢₜ and f_{attend} may take different forms according to experimentation and design considerations. As a basic implementation, f_{attend} can compute the dot product of its two arguments, though it may be more complicated and fₑₘᵢₜ could be nearly any function, but can be a form of feed-forward neural network. In some instances, the specification should be based on experimentation and available resources. Different kinds of internal layers may be used, such as the “dilated causal convolutional” layers used by WaveNet. In some instances, fₑₘᵢₜ can emit a single “stop” score indicating that it can stop producing output. Variables h and o can be vectors, though all that is necessary is that the function (using h and o) be trainable via back-propagation. As a basic implementation, it could be configured to be a 2- or 3-hidden layer neural network with linear rectifiers as non-linearities.

In some instances, training proceeds by back-propagating an error signal through the network in a usual way. The system estimates parameters for fₑₘᵢₜ and f_{attend}, as well as those used in the in the context vector computation step. The choice of error function may impact performance, and can, for example, be chosen by experimentation. Cross-entropy or Euclidean distances may be appropriate depending on the chosen output representation.

Output Representation

While the system can be configured to produce any output representation that is appropriate, the performance of the system can be sensitive to that choice and (by extension) the error function used.

### Speech Encoding

One representation of the speech signal is simply the value of a waveform at each time, where time is represented in steps of 1/8000 or 1/160000 of a second. The choice of time step in the signal is related to the bandwidth of the speech to be represented, and this relationship (called the Nyquist criterion) is that the sampling rate should be at least twice the highest bandwidth in the signal. (Narrowband speech, like that of the POTS telephone system, is typically 3,500 Hz wide, and “broadband” speech, like that found in Skype, is about 6000 Hz wide). This sampled waveform output form is used in Wavenet (reference).

As noted earlier, a more efficient neural network sequence-to-sequence synthesizer may be implemented if the output is not simply the samples of the speech, but some representative vector at each output time which will result in a large number of samples produced by a separate process. The present technology offers several possibilities for this vector representation.

Speech may be represented by a generative model which specifies the smoothed spectrum, the pitch, a noise source, and an energy for each 5 or 10 milliseconds of the signal. That is, at 16,000 samples per second, each vector would represent 80 samples of speech for 5 ms frames, or 160 samples of speech at 10 ms frames.

If the vector representing a frame of speech consisted of the frequencies and bandwidths of 3 “formants” (broad resonances), the pitch of the signal if it is periodic, a noise signal, and the power of the frame, then speech samples can be reproduced by creating a filter with the characteristics of the three formants, and filtering a signal mixing pitch and noise (or just noise) with that filter. One simple “formant vocoder” could involve parameters of the vocoder, suitably hand tuned, used to reproduce iso-preferential speech compared to the original signal. That is, the speech signal could be transformed into vocoder parameters, and those parameters could be used to recreate the speech signal, and the recreated speech signal sounded the same as the original signal.

This example simply demonstrates that the vocoder could create natural speech signals if the parameters were appropriately specified. This characteristic will generally be true of vocoders described here, with the exception of distortions associated with quantization or other approximations.

In some instances, an LPC vocoder could be implemented. An LPC all-pole model of the spectrum of speech could be computed rapidly from a few hundred speech samples, and the implied filter could be used to filter a pitch/noise composite signal to create speech. In an LPC vocoder, about 12 LPC coefficients can be created for each frame of speech, and pitch is quantized to one of 64 or 128 pitch values. Some implementations offer a mixed excitation, where white noise starting at some frequency is mixed with the pitch signal. An amplitude value is associated with each frame, typically to about 1 dB, or a total range of about 50 values in all.

In other vocoders, the spectrum is represented as LPC parameters, the pitch is measured, but then the residual signal (after accounting for the long term spectrum and the pitch) is further described with a multi-pulse signal, (called multi-pulse vocoder), or with a random signal selected from a codebook (called CELP, for codebook excited LPC). In either case, however, the representation of a collection of speech samples is compactly described by about 12 LPC coefficients and an energy, pitch, and noise representation. (Note that LPC coefficients when subject to distortion or quantization, can lead to unstable filters, and that a stable, equivalent representation known as reflection coefficients are often used in real systems).

Modern codecs such as Speex, Opus, and AMR are modifications of the basic LPC vocoder, often with much attention to variable bit rate outputs and to appropriate quantization of parameters. For this work the quantization is irrelevant, and The present technology manipulates the unquantized values directly. (Quantization may be applied in a post-processing step.) In the codebook associated with CELP, however, for the random code which is used to cancel the error, there is a quantization implied which the present technology keeps.

These modern codecs result in very little qualitative degradation of voice quality when the bitrate is set high enough, e.g., 16 kHz audio encoded using the SPEEX codec at 28000 bits/second is nearly indistinguishable from the original audio whose bitrate is 256000 bits/second. As such, an algorithm that could accurately predict the fixed rate high bitrate codec parameters directly from text would sound very natural.

The other advantage of predicting codec parameters is that once computed they can be passed directly to standard audio pipelines. At this constant bitrate, SPEEX produces 76 codec parameters 50 times a second. The task of predicting these 76 parameters 50 times per second is a much simpler machine learning problem—in terms of both learning and computational complexity—than WAVENET's task of predicting a mulaw value 16000 times per second. In addition, the problem of predicting codec parameters is made easier because the majority of these parameters are codebook indices, which are naturally modeled by a softmax classifier.

Optionally, one embodiment may use a coder which extends fluently to non-speech signals, like Opus in which Discrete Cosine Transforms are applied to various signal types (i.e., the upper band of broadband speech, or the entire signal itself if it is non-speech) in addition to a speech-specific coding of the lower band of the speech signal. In this class of coders, complexity is increased for better non-speech signal fidelity.

Other representations of speech are also possible—one may represent voiced speech as a pitch and the energy of each harmonic of the pitch, or one could represent the smooth spectrum of speech as simply the energy values of several bands covering the speech frequencies. Whatever the vocoder representation used, it always has some spectral representation, some pitch measure, some noise measure, and an energy. Values are either represented directly, or they are encoded in a codebook either singly or multiply.

While so far ways of generating audio encoding directly have been described, it is in fact possible to feed the outputs of our system directly into a modified version of WaveNet. In particular, recall that the WaveNet architecture accepts a number of frames with per-frame features including phone identity, linguistic features and F0 and outputs a fixed number of samples (the number being a linear function of the number of input frames), while the system described here takes input features (possibly but not necessarily including phone, F0, and linguistic features) that are not per-frame (indeed there are no frames in the input to our system), and outputs a variable number of frames of audio encoded under some codec.

The WaveNet architecture (or an architecture substantially similar) can instead trivially be reconfigured to accept a sequence of arbitrary vectors as input, and then output audio samples according to its learned model. In this mode, WaveNet is basically a vocoder that learns the transformation from its inputs to waveforms. Our system can then be configured to output vectors of the length that WaveNet expects as input. This new joint network can then be trained jointly via backpropagation for a complete “zero-knowledge” text-to-speech system.

The correlations of the values associated with any particular vocoder have different temporal spans. Smoothed spectra of speech (the formants, or the LPC coefficients) tend to be correlated for 100 to 200 milliseconds in speech, a time which is about the length of vowels in the speech signal. Pitch signals move more slowly, and may be correlated for a half second or longer. Energy during vowels tends to be correlated for hundreds of milliseconds, but may demonstrate large swings over short times (10-20 milliseconds) in consonants like /p/ or /b/. The different parts of the speech signal suggest that a non-waveform coder should be able to represent the speech with more efficiency than the waveform coder itself, but to date, with the exception of the work of John Holmes cited above, there has been little attempt to correct the transformation effects designed into the coders by human engineers. This patent offers to correct this oversight.

### Network Output and Error Functions

The frame structure used by a variety of audio codecs, with the exception of waveforms, where a single (quantized) value is used for each sample, involves a few vectors (e.g. for spectrum and for residual), a few scalars (e.g. pitch), and (possibly) a few discrete values for codebook entries and the like.

The vector- and real-valued parts of the output can be produced directly by the neural network. For these, the use of a stable representation such as reflection coefficients is important, so that small perturbations to the signal do not produce drastically different results, especially if an error metric like Euclidean distance is used, which is relatively insensitive to small perturbations.

For quantized or discrete values, these are often best treated as classes, where the system is asked to output a probability for each possible value, and the system should use an error function like cross-entropy between the predicted distribution and the desired target.

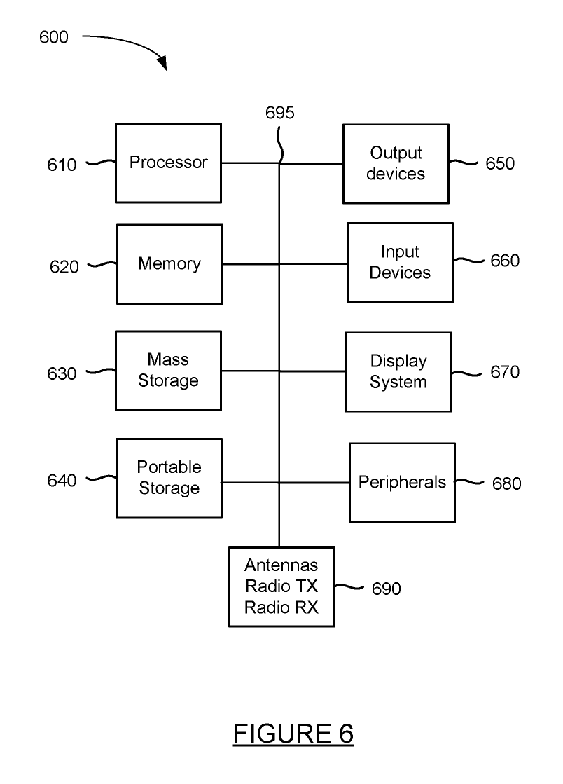

FIG. 6 is a block diagram of a computer system 600 for implementing the present technology. System 600 of FIG. 6 may be implemented in the contexts of the likes of client 610, mobile device 620, computing device 630, network server 650, application server 660, and data stores 670.

The computing system 600 of FIG. 6 includes one or more processors 610 and memory 620. Main memory 620 stores, in part, instructions and data for execution by processor 610. Main memory 610 can store the executable code when in operation. The system 600 of FIG. 6 further includes a mass storage device 630, portable storage medium drive(s) 640, output devices 650, user input devices 660, a graphics display 670, and peripheral devices 680.

The components shown in FIG. 6 are depicted as being connected via a single bus 690. However, the components may be connected through one or more data transport means. For example, processor unit 610 and main memory 620 may be connected via a local microprocessor bus, and the mass storage device 630, peripheral device(s) 680, portable or remote storage device 640, and display system 670 may be connected via one or more input/output (I/O) buses.

Mass storage device 630, which may be implemented with a magnetic disk drive or an optical disk drive, is a non-volatile storage device for storing data and instructions for use by processor unit 610. Mass storage device 630 can store the system software for implementing embodiments of the present invention for purposes of loading that software into main memory 620.

Portable storage device 640 operates in conjunction with a portable non-volatile storage medium, such as a compact disk, digital video disk, magnetic disk, flash storage, etc. to input and output data and code to and from the computer system 600 of FIG. 6. The system software for implementing embodiments of the present invention may be stored on such a portable medium and input to the computer system 600 via the portable storage device 640.

Input devices 660 provide a portion of a user interface. Input devices 660 may include an alpha-numeric keypad, such as a keyboard, for inputting alpha-numeric and other information, or a pointing device, such as a mouse, a trackball, stylus, or cursor direction keys. Additionally, the system 600 as shown in FIG. 6 includes output devices 650. Examples of suitable output devices include speakers, printers, network interfaces, and monitors.

Display system 670 may include a liquid crystal display (LCD), LED display, touch display, or other suitable display device. Display system 670 receives textual and graphical information, and processes the information for output to the display device. Display system may receive input through a touch display and transmit the received input for storage or further processing.

Peripherals 680 may include any type of computer support device to add additional functionality to the computer system. For example, peripheral device(s) 680 may include a modem or a router.

The components contained in the computer system 600 of FIG. 6 can include a personal computer, hand held computing device, tablet computer, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Apple OS or iOS, Android, and other suitable operating systems, including mobile versions.

When implementing a mobile device such as smart phone or tablet computer, or any other computing device that communicates wirelessly, the computer system 600 of FIG. 6 may include one or more antennas, radios, and other circuitry for communicating via wireless signals, such as for example communication using Wi-Fi, cellular, or other wireless signals.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A method for performing speech synthesis, comprising:
receiving one or more streams of input by one or more decoders implemented on a computing device;
generating a context vector by the one or more encoders;
decoding the context vector by a decoding mechanism implemented on the computing device;
feeding the decoded context vectors into a neural network implemented on the computing device; and
providing an audio file from the neural network.

2. The method of claim 1, wherein the streams of input include original text data and pronunciation data.

3. The method of claim 2, wherein one or more streams are processed simultaneously as a single process.

4. The method of claim 1, wherein decoding the context vector includes generating an attention vector.

5. The method of claim 1, wherein decoding the context vector includes computing an attention score.

6. The method of claim 1, wherein decoding the context vector includes computing an attention distribution.

7. The method of claim 1, wherein the system provides text-to-speech function to an automated assistant system.

8. The method of claim 1, further comprising determining to end processing of the one or more streams of input upon processing a stop frame.

9. The method of claim 1, wherein the audio file includes compressed audio frames.

10. A system for performing speech synthesis, comprising:
one or more encoder modules stored in memory and executable by a processor that when executed receive one or more streams of input and generate a context vector for each stream; and
a decoder module stored in memory and executable by a processor that when executed decodes the context vector, feeds the decoded context vectors into a neural network, provides an audio file from the neural network.

11. The system of claim 10, wherein the streams of input include original text data and pronunciation data.

12. The system of claim 11, wherein one or more streams are processed simultaneously as a single process.

13. The system of claim 10, wherein decoding the context vector includes generating an attention vector.

14. The system of claim 10, wherein decoding the context vector includes computing an attention score.

15. The system of claim 10, wherein decoding the context vector includes computing an attention distribution.

16. The system of claim 10, wherein the system provides text-to-speech function to an automated assistant system.

17. The system of claim 10, further comprising determining to end processing of the one or more streams of input upon processing a stop frame.

18. The system of claim 10, wherein the audio file includes compressed audio frames.
